(19) United States
(12) Patent Application Publication
(10) Pub. No.: US 2014/0239872 A1
(43) Pub. Date: Aug. 28, 2014

(54) PULSED-MOTOR DRIVING APPARATUS AND PULSED-MOTOR DRIVING METHOD

(71) Applicant: NK WORKS CO., LTD., Wakayama (JP)

(72) Inventor: Toshiro Akira, Wakayama (JP)

(73) Assignee: NK WORKS CO., LTD., Wakayama (JP)

(21) Appl. No.: 14/185,210

(22) Filed: Feb. 20, 2014

(30) Foreign Application Priority Data
Feb. 22, 2013 (JP) 2013-033708

(51) Int. Cl. H02P 8/14

(52) U.S. Cl. CPC H02P 8/14
USPC 318/696

(57) ABSTRACT

The inventive apparatus includes a driving clock generating section generating a driving clock having a driving frequency and driving a pulsed motor based on an inputted base clock having a base frequency; wherein in a predetermined period. The driving clock generating section operates in a through-output mode in which the base clock is outputted as the driving clock and in an idle mode in which during an idle period a stationary signal not including any pulse is outputted as the driving clock. The idle period is configured such that an average frequency of the driving clock during the predetermined period is equal to the driving frequency.

### TECHNICAL FIELD

The present invention relates to a technique of driving a pulsed motor at a driving frequency lower than a self-starting frequency.

### BACKGROUND ART

There is known a motor called a pulsed motor (a stepper motor) which is rotated according to a clock (pulses) inputted thereto. As such pulsed motor allows precision control of its rotation, it is being used in various fields including a conveyer mechanism in e.g. a printer.

Such pulsed-motor has a characteristics called a self-starting frequency and generally is driven at a driving frequency lower than this self-starting frequency. Depending on an application of the pulsed motor, there sometimes arises a need for driving it at a frequency much lower than its self-starting frequency. However, self-starting frequencies of standard two-phase pulsed motors range around 500 pps. Thus, if a pulsed motor is driven at a driving frequency much lower than the above, a significant vibration may occur (see Patent Document 1). Further, there may also occur resonance with other device using the pulsed motor. Such resonance is undesirable since it invites torque reduction, step-out, etc. of the motor.

Conventionally, in order to solve such problems as above at the time of low-frequency driving of the pulsed motor, the art would provide a pulley or employ a special pulsed-motor. Further, Patent Document 2 proposes driving in 1-2 phase excitation mode at the time of low speed driving.

### PRIOR-ART DOCUMENTS

### Patent Documents

[Patent Document 1] Japanese Unexamined Patent Application Publication No. 2011-035990

[Patent Document 2] Japanese Unexamined Patent Application Publication No. 62-002895

### SUMMARY OF THE INVENTION

### Object to be Achieved by Invention

However, with the above-described methods, there would occur such problems as narrowing of speed control range, increased manufacture cost, etc.

In view of the above, the object of the present invention is to provide a pulsed-motor driving technique that allows low-speed driving of a pulsed motor with a simple configuration.

### Solution to Achieve Object

According to one preferred embodiment of a pulsed-motor driving apparatus relating to the present invention, including a driving clock generating section generating a driving clock having a driving frequency and driving a pulsed motor based on an inputted base clock having a base frequency; wherein in a predetermined period, the driving clock generating section operates in a through-output mode in which the base clock is outputted as the driving clock and in an idle mode in which during an idle period a stationary signal not including any pulse is outputted as the driving clock; and the idle period is configured such that an average frequency of the driving clock during the predetermined period is equal to the driving frequency.

With the above-described arrangement, the driving clock generated by the pulsed-motor driving apparatus of the invention includes a portion constituted of clock signals having a same frequency as the base clock and a portion constituted of a stationary signal (a signal having 0 frequency). Therefore, if the base frequency is set at a frequency at which vibration or the like will not occur, resonance or the like will not occur with whichever portion of the driving clock being fed to the pulsed motor. On the other hand, when the predetermined period as a whole is considered, since the average frequency of the driving clock is made equal to or in agreement with the driving frequency, for this predetermined period as a whole, the frequency of the driving clock can be set lower than the base frequency. Namely, the pulsed motor can be driven at a frequency lower than the base frequency.

Moreover, since the above-described configuration is made simple as an arrangement of simple switchover between a through-output mode and an idle mode, based on an idle period, there is no risk of inviting significant cost increase. Moreover, the configuration made simple as above allows setting of any desired driving frequency.

According to one preferred embodiment of the pulsed-motor driving apparatus of the present invention, the apparatus comprises a base pulse counting section for counting a number of pulses included in the base clock as a detected pulse number; and the driving clock generating section operates in the through-output mode from a starting stage of the predetermined period and operates in the idle mode from a timing when the detected pulse number in the predetermined period exceeds a pulse number in the predetermined period determined based on the driving frequency to an ending stage of the predetermined period.

With the above-described configuration, the switchover between the through-output mode and the idle mode is made possible by the simple arrangement of counting the number of base clock signals.

Further, according to one preferred embodiment of a pulsed-motor driving method of the present invention generating a driving clock having a driving frequency and driving a pulsed motor based on an inputted base clock having a base frequency;

wherein the method comprises the steps of:

counting a number of pulses included in the base clock as a detected pulse number;

outputting the base clock as the driving clock from a starting stage of the predetermined period; and

outputting a stationary signal containing no pulse is outputted as the driving pulse from a timing when the detected pulse number in the predetermined period exceeds a pulse number in the predetermined period determined based on the driving frequency to an ending stage of the predetermined period.

This pulsed-motor driving method too achieves the same advantageous function/effect as the pulsed-motor driving apparatus described above. And, to this pulsed-motor driving method too, the above-described additional features for the pulsed-motor driving apparatus can be applied.

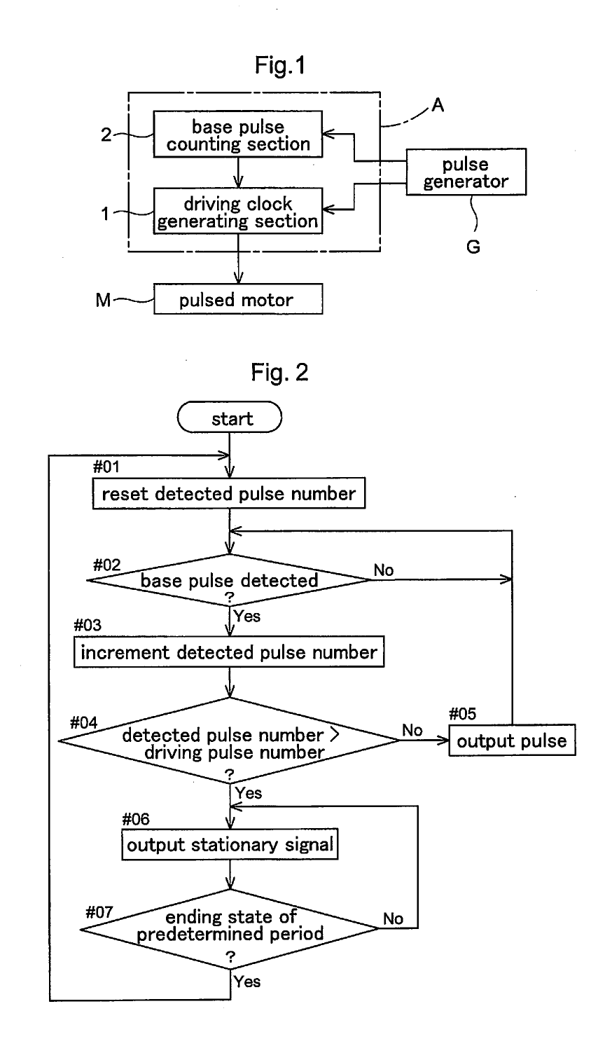

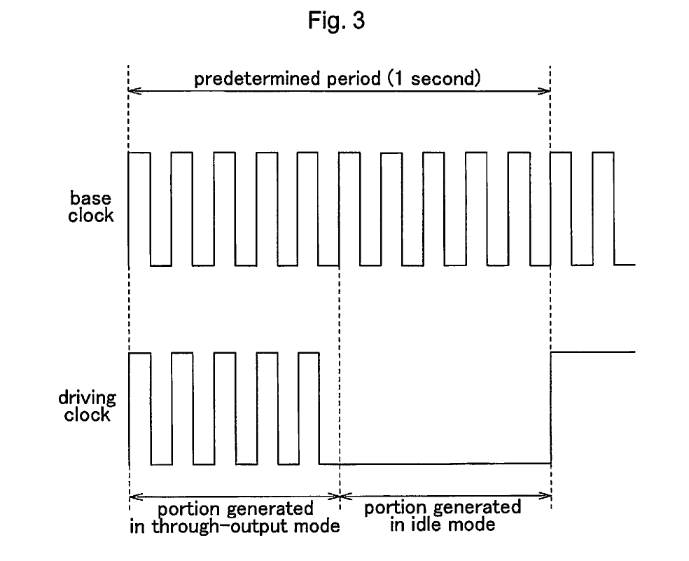

### BRIEF DESCRIPTION OF THE DRAWINGS

[FIG. 1] is a functional block diagram of a pulsed-motor driving apparatus,

[FIG. 2] is a flowchart illustrating a flow of a processing by the pulsed-motor driving apparatus, and

[FIG. 3] is a diagram showing relationship between a base clock and a driving clock generated by the pulsed-motor driving apparatus according to the invention.

### MODES OF EMBODYING INVENTION

Next, embodiments of a pulsed-motor driving apparatus of the invention will be explained with reference to the accompanying drawings. FIG. 1 is a functional block diagram of a pulsed-motor driving apparatus relating to this embodiment. As shown, to the pulsed-motor driving apparatus A, there are connected a pulsed motor M to be driven and a pulse generator G generating a base clock having a base frequency. The pulse motor M and the pulse generator G are standard type, so explanation thereof will be omitted herein. Incidentally, it is preferred that the base frequency be a frequency higher than a frequency where resonance occurs. For instance, the base frequency can be a self-starting frequency of the pulsed motor M.

Incidentally, the term: “a pulse” means one cycle of clock. For instance, a pulse is constituted of a signal from rising of the clock to a timing immediately before the next rising thereof. In particular, the pulse of the base clock will be referred to as a base pulse and the pulse of a driving clock will be referred to as a driving pulse, respectively.

As shown in FIG. 1, the pulsed-motor driving apparatus A according to this embodiment includes a driving clock generating section 1 and a base pulse counting section 2. The driving clock generating section 1 and the base pulse counting section 2 input a base clock.

The driving clock generating section 1 is configured to operate in either a through-output mode or an idle mode. The through-output mode is a mode in which an inputted base clock (a base pulse) is outputted as it is as a driving clock (a driving pulses). On the other hand, the idle mode is a mode in which a stationary signal containing no pulse is outputted as a driving pulse. For instance, in this idle mode, a stationary signal of 0 (zero) V is outputted. More particularly, in the through-output mode, a signal having a same frequency as a base frequency is outputted; whereas, in the idle mode, a signal having 0 (zero) frequency is outputted.

The base pulse counting section 2 counts a number of base pulses of the inputted base clock as a detected pulse number. As will be described later, this detected pulse number is utilized for switchover between the through-output mode and the idle mode of the driving clock generating section 1.

FIG. 2 is a flowchart illustrating a flow of a processing by the pulsed-motor driving apparatus. Incidentally, prior to the processing, a driving pulse number is set. This driving pulse number is a number of driving pulses included in the driving clock signal in a predetermined period, which number is calculated as: the length or duration of the predetermined period (measured in seconds)×(multiplied by) frequency. Therefore, provided the predetermined period is 1 second, the driving pulse number is equal to or in agreement with the driving frequency.

Firstly, upon start of the processing, the base pulse number counting section 2 rests a detected pulse number to 0 (zero) (#01). Upon detection of a base pulse of an inputted base clock signal (YES branching at #02), the base pulse counting section 2 adds 1 (one) to the detected pulse number (#03). The base pulse counting section 2 effects the detection of base pulse, based on e.g. rising of the base clock.

If the detected pulse number is smaller than the driving pulse number (NO branching at #04), the driving clock generating section 1 operates in the through-output mode to output an inputted base clock (base pulse) as a driving clock (a driving pulse) (#05). Thereafter, the process goes to #02. That is, while the detected pulse number is smaller than the driving clock number, the driving clock generating section 1 operates in the through-output mode.

On the other hand, if the detected pulse number exceeds the driving pulse number (YES branching at #04), the driving clock generating section 1 enters the idle mode and outputs a stationary signal of e.g. 0 V as a driving clock signal (#06). The output of this stationary signal, that is, the idle mode of the driving clock generating section 1 is continued until the ending stage of the predetermined period (#07). Incidentally, the ending stage of the predetermined period may be detected by time measurement by an unillustrated timer or may be detected based on the base pulse number.

When the processing is executed to the ending stage of the predetermined period, the process returns to #01 to effect the 0 resetting of the detected pulse number and the above-described process is repeated.

FIG. 3 is a diagram showing relationship between an inputted base clock and a driving clock generated by the pulsed-motor driving apparatus by the above-described process. In this example, the predetermined period is set as 1 (one) second, the base frequency is set as 10 pps and the driving frequency is set as 5 pps, respectively.

As shown in the drawing, the former half of the driving clock in the predetermined period is comprised of a plurality of pulses and the latter half thereof is comprised of a stationary signal. The former half is the portion generated by the driving pulse generating section 1 operating in the through-output mode. Whereas, the latter half is the portion generated by the driving pulse generating section 1 operating in the idle mode.

When only the former half is viewed, as this portion is comprised of base pulses of the base clock, the frequency of the driving clock of this former half is 10 pps which is same as the base frequency. Therefore, when the pulsed motor M is driven by the driving clock of this former half, no inconvenience such as resonance occurs.

On the other hand, when only the latter half is viewed, this portion is comprised solely of the stationary signal. Therefore, when the driving clock of this latter half is fed to the pulsed motor M, the pulsed motor M is not driven. Therefore, no inconvenience such as resonance occurs, as a matter of course.

Now, when the driving clock of the whole predetermined period is viewed, five pulses in total are included within the duration of 1 second. Therefore, the average frequency of the driving clock during the predetermined period is 5 pps, which is equal to or agrees with the driving frequency. Accordingly, when the predetermined period as a whole is considered, the frequency of the driving clock is lower than the base frequency.

In this way, the driving clock generated by the pulsed-motor driving apparatus A according to the present invention includes a portion consisting of clock having the same frequency as the base frequency and a portion consisting of a stationary signal (that is, a clock signal having 0 (zero) frequency). Thus, in whichever portion the pulsed motor M is driven, no resonance will occur in the pulsed motor M. On the other hand, when the predetermined period as a whole is considered, the number of driving pulses included in the driving clock is made smaller than the number of base pulses included in the base clock. In other words, the average frequency of the driving clock during the predetermined period is made lower than the frequency of the base clock.

As described above, with the pulsed-motor driving apparatus of the present invention, low-speed driving of a pulsed motor can be realized without occurrence of resonance. Moreover, as its configuration is the simple arrangement of setting an idle period based on a base pulse number, there is no possibility of significant cost increase. Further, thanks to such simple configuration, the driving frequency can be set as desired.

1. A pulsed-motor driving apparatus including a driving clock generating section generating a driving clock having a driving frequency and driving a pulsed motor based on an inputted base clock having a base frequency;
wherein in a predetermined period, the driving clock generating section operates in a through-output mode in which the base clock is outputted as the driving clock and in an idle mode in which during an idle period a stationary signal not including any pulse is outputted as the driving clock; and
wherein the idle period is configured such that an average frequency of the driving clock during the predetermined period is equal to the driving frequency.

2. A pulsed-motor driving apparatus according to claim 1, wherein the apparatus comprises a base pulse counting section for counting a number of pulses included in the base clock as a detected pulse number; and
wherein the driving clock generating section operates in the through-output mode from a starting stage of the predetermined period and operates in the idle mode from a timing when the detected pulse number in the predetermined period exceeds a pulse number in the predetermined period determined based on the driving frequency to an ending stage of the predetermined period.

3. A pulsed-motor driving method generating a driving clock having a driving frequency and driving a pulsed motor based on an inputted base clock having a base frequency;
wherein the method comprises the steps of:
counting a number of pulses included in the base clock as a detected pulse number;
outputting the base clock as the driving clock from a starting stage of the predetermined period; and
outputting a stationary signal containing no pulse is outputted as the driving pulse from a timing when the detected pulse number in the predetermined period exceeds a pulse number in the predetermined period determined based on the driving frequency to an ending stage of the predetermined period.
